(19) United States
(12) Patent Application Publication
(10) Pub. No.: US 2008/0091385 A1
(43) Pub. Date: Apr. 17, 2008

(54) CABLE USE TRACKING APPARATUS

(75) Inventors: QIAN-SHENG LIU, Shenzhen (CN); XIAN-MING WANG, Shenzhen (CN); GUANG-DONG YUAN, Shenzhen (CN); CHUNG-CHI HUANG, Tu-Cheng (TW)

Correspondence Address: PCE INDUSTRY, INC.;ATT. CHENG-JU CHIANG JEFFREY T. KNAPP, 458 E. LAMBERT ROAD, FULLERTON, CA, 92835, US

(73) Assignees: HONG FU JIN PRECISION INDUSTRY (ShenZhen) CO., LTD., Shenzhen City (CN); HON HAI PRECISION INDUSTRY CO., LTD., Tu-Cheng (TW)

(21) Appl. No.: 11/778,076

(22) Filed: Jul. 16, 2007

(30) Foreign Application Priority Data
Oct. 13, 2006 (CN) 200610063092.3

(51) Int. Cl. G06F 17/40

(52) U.S. Cl. 702/187

(57) ABSTRACT

A cable use tracking apparatus includes a switch module fixed to a cable, a detecting module, and a computer communicating with the detecting module. The switch module switches from a first state to a second state based on activity of the cable relative to an electronic device. The detecting module detects the switching of the states, and outputs result indicating signals. The computer counts and displays the number of times that the cable is used based on the indicating signals.

### BACKGROUND OF THE INVENTION

1. Field of the Invention

The present invention relates to an use tracking apparatus for cables.

2. Description of Related Art

After electronic devices are manufactured in a factory, performance of the electronic devices should be tested. Cables are used for connecting testing devices with electronic devices under test. Frequent plugging and unplugging of the electronic devices can wear out the cables. The cables thus need to be changed in time to avoid impairing the effect of the performance tests.

Specification of a cable often provides the operating life of the cable. When the number of times that a cable is used is known, the user can determine whether the cable needs to be changed or not, by comparing the number of times with the operating life.

What is needed, therefore, is a cable use tracking apparatus, which can determine the number of times that a cable is used in connecting with an electronic device.

### SUMMARY OF THE INVENTION

A cable use tracking apparatus for determining the number of times that a cable is used in connecting with an electronic device is provided. In a preferred embodiment, the cable use tracking apparatus includes a switch module fixed to a cable, a detecting module, and a computer communicating with the detecting module. The switch module includes a first state and a second state. The switch module switches from the first state to the second state based on activity of the cable relative to the electronic device. The detecting module detects the switching of the states, and outputs result indicating signals. The computer counts and displays the number of times that the cable is used based on the indicating signals.

Other advantages and novel features will become more apparent from the following detailed description when taken in conjunction with the accompanying drawings, in which:

### BRIEF DESCRIPTION OF THE DRAWINGS

FIG. 1 is a schematic diagram of a cable use tracking apparatus in accordance with an embodiment of the present invention;

FIG. 2 is a schematic diagram of a cable of FIG. 1 before the cable is plugged in a socket of an electronic device; and

FIG. 3 is a schematic diagram of the cable of FIG. 2 after the cable is plugged in the socket.

### DETAILED DESCRIPTION OF THE INVENTION

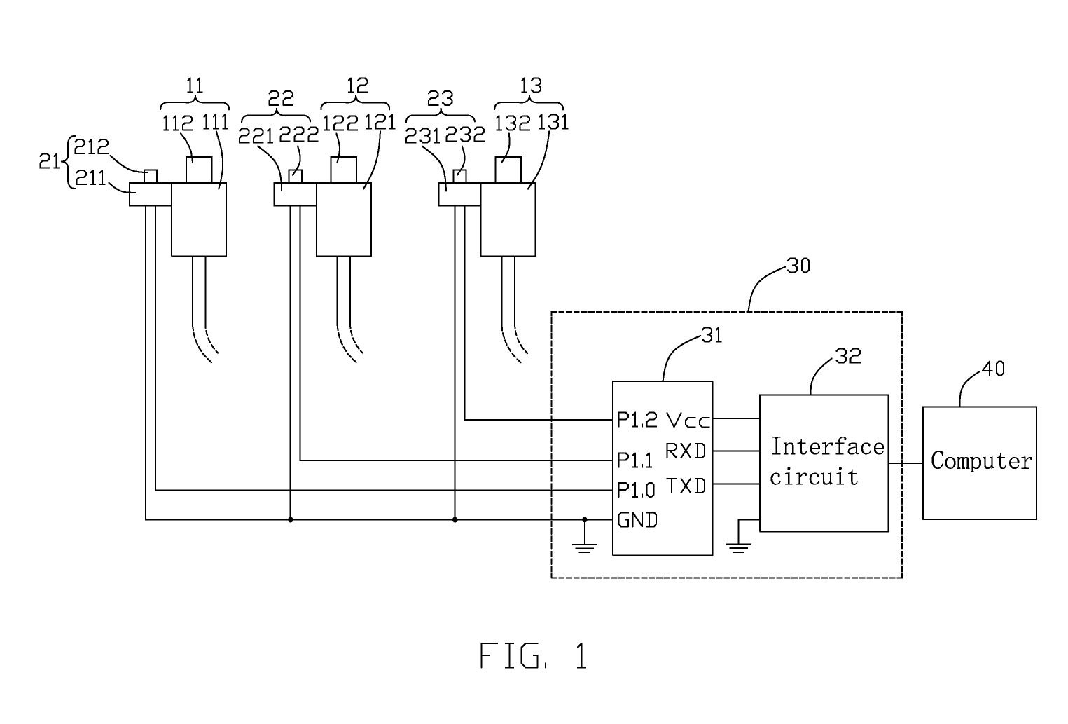

Referring to FIG. 1, a cable use tracking apparatus in accordance with an embodiment of the present invention includes switch modules 21, 22, 23, a detecting module 30, and a computer 40. The cable use tracking apparatus is used for determining the number of times that cables 11, 12, and 13 are used in connecting with electronic devices (not shown).

The cable 11, 12, 13 includes a rectangular base 111, 121, 131 and a connecting member 112, 122, 132 extending up from the base 111, 121, 131. When the cables 11, 12, and 13 are used for connecting testing devices with the electronic devices under test, the connecting members 112, 122, and 132 of the cables 11, 12, and 13 are respectively plugged in sockets of the electronic devices. When testing is done, the connecting members 112, 122, and 132 are respectively pulled out of the sockets of the electronic devices.

The switch modules 21, 22, 23 can be button switches. The switch modules 21, 22, 23 include rectangular shaped main bodies 211, 221, 231 and buttons 212, 222, 232 respectively protruding from upper surfaces of the main bodies 211, 221, 231. Each switch module 21, 22, 23 includes a first contact and a second contact therein. The main bodies 211, 221, 231 of the switch modules 21, 22, 23 are respectively fixed to sides of the bases 111, 121, 131, with upper surfaces of the main bodies 211, 221, 231 respectively be on a same level with upper surfaces of the bases 111, 121, 131.

The detecting module 30 includes a microprocessor 31 for communicating with the switch modules 21, 22, 23, and an interface circuit 32 for converting signals from the microprocessor 31 to signals that can be used by the computer 40. First contacts of the switch modules 21, 22, 23 are respectively connected to ports P1.0, P1.1, P1.2 of the microprocessor 31. Second contacts of the switch modules 21, 22, 23 are connected to ground port GND of the microprocessor 31. Ports TXD, RXD, Vcc of the microprocessor 31 are connected to the interface circuit 32.

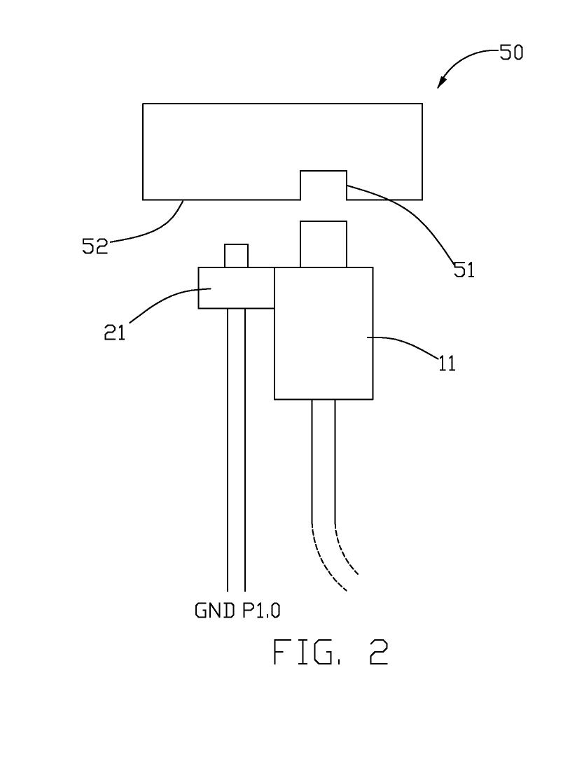

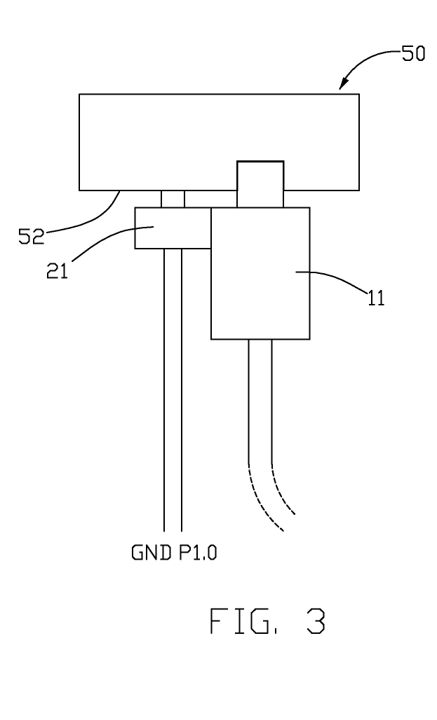

FIG. 2 and FIG. 3 are respectively schematic diagrams of the cable 11 before it is plugged in a socket 51 of an electronic device 50 and after it is plugged in the socket 51. After the cable 11 is plugged in the socket 51, the switch module 21 is pressed by a surface 52 adjacent to the socket 51. The switch module 21 thus turns on. The P1.0 of the microprocessor 31 is connected to ground. Therefore, the level state of the port P1.0 of the microprocessor 31 changes.

Likewise, after the cables 12, 13 are plugged in corresponding sockets, the switch modules 22, 23 turn on. The detecting module 30 detects the switching of states of the switch modules 21, 22, 23, and outputting result indicating signals to the computer 40. The computer 40 includes a processing module, for receiving the indicating signals, and counting the number of times that the cables 11, 12, 13 are used based on the indicating signals, for example, the number of times that the cable 11 is used is increased by 1 when the P1.0 of the microprocessor 31 is connected to ground once, and a monitor for displaying the number of times. When the number of times are known, the user can determine whether the cables 11, 12, 13 need to be changed or not, by comparing the number of times with the operating life of the cables 11, 12, 13. Further, when the cables 11, 12, 13 are broken, the user can evaluate the quality of the cables 11, 12, 13 based on the corresponding number of times that the cables 11, 12, 13 have been used.

The embodiment was chosen and described in order to explain the principles of the invention and their practical application so as to enable others skilled in the art to utilize the invention and various embodiments and with various modifications as are suited to the particular use contemplated. Alternative embodiments will become apparent to those skilled in the art to which the present invention pertains without departing from its spirit and scope. Accordingly, the scope of the present invention is defined by the appended claims rather than the foregoing description and the exemplary embodiments described therein.

What is claimed is:

1. A cable use tracking apparatus for determining the number of times that a cable is used in connecting with an electronic device, the cable use tracking apparatus comprising:
a switch module being fixed to the cable, the switch module comprising a first state and a second state and being capable of switching from the first state to the second state in response to connection of the cable with the electronic device;
a detecting module for detecting the switching of the states, and outputting result indicating signals; and
a computer communicating with the detecting module, for counting and displaying the number of times that the cable is used based on the indicating signals.

2. The cable use tracking apparatus as claimed in claim 1, wherein the switch module comprises a mainbody, a button protruding from an upper surface of the mainbody, and two contacts therein, the button being pressed to connect with the two contacts when the cable is connected with the electronic device.

3. The cable use tracking apparatus as claimed in claim 2, wherein the mainbody of the switch module is fixed to a base of the cable, with the upper surface of the mainbody be on a same level with an upper surface of the base.

4. The cable use tracking apparatus as claimed in claim 2, wherein the detecting module comprises a microprocessor for communicating with the switch module, and an interface circuit for converting signals from the microprocessor to signals that can be used by the computer.

5. The cable use tracking apparatus as claimed in claim 4, wherein the two contacts of the switch module are respectively connected to a port of the microprocessor and ground such that when the cable is connected with the electronic device, the port of the microprocessor is grounded via the two contacts which results in the computer incrementing the number of times that the cable is used.

6. A cable use tracking apparatus for determining the number of times that a cable is used in connecting with an electronic device, the cable use tracking apparatus comprising:
a switch means being fixed to the cable, the switch means comprising a first state and a second state, the switch means switching from the first state to the second state based on activity of the cable relative to the electronic device;
a detecting means for detecting the switching of the states, and outputting result indicating signals; and
a processing means for receiving the indicating signals, and counting the number of times that the cable is used based on the indicating signals.

7. The cable use tracking apparatus as claimed in claim 6, wherein the switch means comprises a mainbody, a button protruding from an upper surface of the mainbody, and two contacts therein, the button being pressed to connect with the two contacts when the cable is connected with the electronic device.

8. The cable use tracking apparatus as claimed in claim 7, wherein the mainbody of the switch means is fixed to a base of the cable, with the upper surface of the mainbody be on a same level with an upper surface of the base.

9. The cable use tracking apparatus as claimed in claim 6, wherein the activity of the cable comprises a connecting member of the cable being plugged in a socket of the electronic device.

10. The cable use tracking apparatus as claimed in claim 7, wherein the detecting means comprises a microprocessor for communicating with the switch means, and an interface circuit for converting signals from the microprocessor to signals that can be used by the processing means.

11. The cable use tracking apparatus as claimed in claim 10, wherein the two contacts of the switch means are respectively connected to a port of the microprocessor and ground such that when the cable is connected with the electronic device, the port of the microprocessor is grounded via the two contacts which results in the microprocessor incrementing the number of times that the cable is used.

12. A cable use tracking apparatus for determining the number of times that a cable is used in connecting with electronic devices, the cable comprising a base and a connecting member protruding from the base configured to connect with the electronic device, the cable use tracking apparatus comprising:
a switch module fixed to the base of the cable, the switch means comprising a first state and a second state and being capable of switching from the first state to the second state when the connecting member of the cable is connected with one of the electronic devices, the switch module comprising two contacts;
a detecting module comprising two ports connected with the two contacts respectively, configured for detecting the switching of the switch module from the first state to the second state and outputting result indicating signals; and
a processing module configured for receiving the indicating signals, and counting the number of times that the cable is used based on the indicating signals.

13. The cable use tracking apparatus as claimed in claim 12, wherein one of the ports of the detecting module is connected to ground, and the switch module comprises a mainbody fixed with the base of the cable, and a button protruding from the mainbody and being pressed to connect with the two contacts when the cable is connected with one of the electronic devices such that the other one of the ports of the microprocessor is grounded via the two contacts which results in the processing module incrementing the number of times that the cable is used.

14. The cable use tracking apparatus as claimed in claim 13, wherein the detecting module comprises a microprocessor configured to communicate with the switch module, and an interface circuit configured to convert signals from the microprocessor to signals that is capable of being processed by the computer. _
